(19) United States
(12) Patent Application Publication
(10) Pub. No.: US 2017/0054334 A1
(43) Pub. Date: Feb. 23, 2017

(54) ELECTRIC DRIVE MOTOR, PUMP, AND A DOMESTIC APPLIANCE COMPRISING SUCH A PUMP

(71) Applicant: BSH Hausgeräte GmbH, Munich (DE)

(72) Inventors: Alfred Binder, Bisingen (DE); Michal Kalavsky, Kosice (SK); Stephan Lutz, Sontheim (DE); Hans-Holger Pertermann, Dresden (DE)

(21) Appl. No.: 15/118,509

(22) PCT Filed: Feb. 5, 2015
(86) PCT No.: PCT/EP2015/052352

§ 371 Date: Aug. 12, 2016

(30) Foreign Application Priority Data
Feb. 12, 2014 (DE) 10 2014 202 570.2

(51) Int. Cl. H02K 1/12; H02K 1/02; H02K 5/12; F04D 17/08; F04D 1/00; D06F 58/28; F04D 25/06; F04D 29/22; F04D 29/28; A47L 15/42; D06F 37/30; A47L 9/00; H02K 1/27; F04D 13/06

(52) U.S. Cl. CPC H02K 1/12; H02K 1/278; H02K 1/02; H02K 5/12; F04D 17/08; F04D 1/00; F04D 13/06; F04D 25/06; F04D 29/22; F04D 29/28; A47L 15/4214; D06F 37/304; A47L 9/0072; D06F 58/28

(57) ABSTRACT

An electric drive motor for a pump includes an electrically actuatable stator winding, and a rotor which is mounted for rotation in a field of the stator winding in the presence of an annular gap. The rotor includes a motor shaft, a magnet carrier disposed on the motor shaft, and at least one permanent magnet arranged on the magnet carrier. The magnet carrier is made from a ferromagnetic chrome steel.

The invention relates to an electric drive motor for a pump, having an electrically actuatable stator winding and a rotor mounted to be rotationally drivable in the field of the stator winding leaving an annular gap and having a motor shaft, a magnet carrier sitting on said motor shaft and at least one permanent magnet arranged on the magnet carrier. The invention also relates to a pump with such a drive motor and to a domestic appliance, particularly a dishwasher, washing machine or dryer, which comprises such an electric drive motor and/or such a pump.

EP 1 788 690 A1 describes a method for producing a permanent magnet rotor for a synchronous motor, in particular for a pump of a washing machine for industrial and private use and suchlike, having an external stator comprising a cylindrical central core with an axis and an axial opening, which is surrounded by a plurality of permanent magnets which have an outer arched surface and an inner arched surface and side edges, comprising the steps of; arranging a bowl-type element made of plastic material comprising a base end, an open end, a side wall and a plurality of longitudinally extending recesses, which are embodied in the side wall and define positioning receptacles for positioning the magnets; introducing the central core into the bowl-type element and arranging the magnets in accordance with the positioning receptacles; injecting a plastic material into the bowl-type element and around this in accordance with the recesses, wherein a cage-type structure with opposing bases and webs which extend between the opposing bases is obtained, wherein the opposing bases abut the ends of the bowl-type element and the webs are received in the recesses.

The object of the invention is to create an electric drive motor in particular for a pump, such as a pump with such a drive motor and a domestic appliance with such a pump, as a result of which the service life and/or the degree of efficiency is/are improved.

The object of the invention is achieved by an electric drive motor for a pump, having an electrically actuatable stator winding and a rotor mounted to be rotationally drivable in the field of said stator winding leaving an annular gap, and comprising a motor shaft, a magnet carrier sitting on the motor shaft and at least one permanent magnet arranged on the magnet carrier, wherein the magnet carrier is produced from a ferromagnetic chrome steel.

By the magnet carrier being produced from a ferromagnetic chrome steel, a corrosion-resistant magnet carrier can be created from a steel material. In other words, the magnet carrier can consist of stainless steel. The corrosion resistance of the magnet carrier increases the service life of the electric drive motor, in particular the pump driven therewith. This is particularly relevant in the case of a wet running meter, which runs at least largely unprotected in a corrosive medium such as water or a washing liquor, such as is the case for instance when used in domestic appliances, such as dishwashers, washing machines and dryers.

With the magnet carrier which is produced from a ferromagnetic chrome steel, this can thus be in particular a soft-magnetic steel material, which can be easily magnetized in a magnetic field. In this respect the magnet carrier should therefore be produced from a ferritic chrome steel. If, however, the magnet carrier is rather to have hard magnetic properties and less soft-magnetic properties, the magnet carrier should be produced from a martensitic chrome steel.

In order to create a sufficiently corrosion-resistant magnet carrier, the magnet carrier should be produced from a particularly ferritic, possibly martensitic chrome steel with a chrome proportion of at least 10.5%. In this way the carbon proportion can amount to at most 1.2% in order to ensure a sufficiently high corrosion resistance. In order to create a ferromagnetic magnet carrier, the chrome steel should be at least substantially or completely nickel-free.

The magnet carrier can thus be produced from a nickel-free chrome steel.

In a preferred embodiment, the magnet carrier can be produced from a chrome steel with a chrome proportion of 16% to 18%, in particular approx. 17%, in particular with the material number 1.4016 according to EN 10027-2 (X6Cr17, AISI 430).

In all embodiments the magnet carrier can be produced from a laminated core of several metal sheets stacked one on top of the other and connected together.

The magnet carrier can thus be produced cost-effectively. To this end individual metal sheets can be stamped or cut from a coil of a rolled sheet steel band and several metal sheets with the same outer contour are stacked to form a laminated core and connected to one another. The individual metal sheets stacked one on top of the other can be connected to one another in a force or form-fit manner by forming individual connecting points of the metal sheets for instance.

As an alternative or in addition to a motor carrier made of ferromagnetic chrome steel, the motor shaft can also be produced from a chrome steel. In other words, the motor shaft can consist of stainless steel.

By the motor shaft being produced from chrome steel, a corrosion-resistant motor shaft made of steel material can be created. The corrosion resistance of the motor shaft increases the service life of the electric drive motor, in particular the pump driven therewith. This is particularly relevant in the case of a wet running meter, which runs at least largely unprotected in a corrosive medium such as water or a washing liquor, such as is the case for instance when used in domestic appliances, such as dishwashers, washing machines and dryers.

The motor shaft can be produced in particular from a curable, in particular austenitic or martensitic chrome steel.

With the motor shaft which is produced from a curable chrome steel, this can thus also involve in particular a soft-magnetic steel material, which can be easily magnetized in a magnetic field. In this respect the motor shaft can thus also be produced from an austenitic-ferritic chrome steel, which are also referred to as duplex steels.

In order to create a sufficiently corrosion-resistant motor shaft, the motor shaft should be produced from a chrome steel with a chrome proportion of at least 10.5%. In this way the carbon proportion can be at most 1.2% in order to ensure a sufficiently high corrosion resistance. In order to also create a curable motor shaft, the chrome steel used for the motor shaft should have a nickel proportion of at least 3%.

In a preferred embodiment, the motor shaft can be produced from a chrome steel with a chrome proportion of 15% to 17%, in particular approx. 16% and a nickel proportion of 3% to 5%, in particular approx. 4%, in particular with the material number 1.4542 according to EN 10027-2 (X5CrNiCuNb16-4, AISI 630).

In a first basic design, each permanent magnet can have a planar base area pointing in the direction of the magnet carrier and the magnet carrier can have a polygonal, in particular hexagonal cross-section.

In a first basic design, each permanent magnet can have a cross-sectionally circular arc-shaped base area pointing in the direction of the magnet carrier, and the magnet carrier can have a circular cross-section.

In all embodiments, the permanent magnets can be fastened on the magnet carrier by means of a plastic cage produced by injection molding the magnet carrier. Each permanent magnet here can have an outer surface abutting the annular gap, said outer surface being delimited by at least one bevel running around the outer surface, wherein the at least one bevel is enclosed in a form-fit manner by the plastic cage.

The width of the annular gap should be reduced as much as possible in order to ensure that the rotating field generated by the electrically actuatable stator winding can act on the rotor with a high degree of efficiency. This can take place by the rotor being designed such that the outer surfaces of the permanent magnets directly abut the annular gap. Since with such an embodiment of the rotor no steel dome is present which completely encapsulates the permanent magnets across their periphery and the permanent magnets are also not completely encased by plastic material, the distance of the outer surfaces of the permanent magnets from the stator winding can be significantly reduced, thereby increasing the degree of efficiency of the electric drive motor. Even if such an improvement in the degree of efficiency also occurs when permanent magnets from a rare earth material are used, one embodiment of the rotor, in which the outer surfaces of the permanent magnets directly abut the annular gap, is then particularly useful if instead of expensive rare earth magnets, ferritic, in particular hard ferritic permanent magnets are preferably used which have a significantly lower magnetic permeability than rare earth magnets. In respect of a cost saving, ferritic, in particular hard ferritic permanent magnets are advantageous however.

By each permanent magnet having an outer surface abutting the annular gap, said outer surface being delimited by at least one bevel running around the outer surface and the at least one bevel being enclosed in a form-fit manner by the plastic cage, as large an area of the outer surface of the permanent magnets as possible can directly abut the annular gap, wherein by means of at least one bevel running around the outer surface, the permanent magnets are held in a form-fit manner on the magnet carrier by the plastic cage, without it requiring a separate steel dome or a plastic cage completely encasing the permanent magnets, as a result of which the permanent magnets are inevitably to be arranged at a greater distance from the stator winding.

All permanent magnets of a rotor are preferably embodied identically. They can, in particular, be arranged at equal distances from one another in a distributed manner across the periphery of the magnet carrier. The outer surfaces of the permanent magnets have a cylinder casing segment-shaped design. The permanent magnets arranged in a distributed manner across the periphery of the magnet carrier can extend their outer surfaces in this respect to form a substantially cylindrical outer surface, which are only interrupted by minor webs of the plastic cage.

As a result of each permanent magnet having at least one peripheral bevel, the permanent magnets arranged around the magnet carrier can be fastened in a form-fit manner on the magnet carrier by means of the injection-molded plastic cage such that the plastic cage, together with the permanent magnets, forms a smooth-walled, cylindrical casing wall of the rotor, which embodies windows which are formed directly by the outer surfaces of the permanent magnets.

By means of the at least one bevel, a particularly balanced ratio can be achieved between the requirement for an outer surface of the permanent magnet which is as large and as magnetically effective as possible and a form-fit encompassing of the permanent magnets by means of the plastic cage which is as reliable as possible for secure fixing on the magnet carrier.

In addition, all embodiments of the magnet carrier can have a hub for receiving the motor shaft, the inner casing wall of which is provided with projecting ribs, which extend in particular in the axial direction. The ribs produce a particularly reliable fastening of the magnet carrier to the motor shaft.

The invention also relates to a pump, having an electric drive motor as described in accordance with the invention, in which the rotor, in particular the magnet carrier thereof and/or the motor shaft thereof is mounted to be rotationally drivable in a wet area of the pump and the outer surfaces of the permanent magnets are in contact with a liquid of the wet area which is disposed in the annular gap of the electric drive motor.

The liquid disposed in the wet area serves inter alia to cool and/or lubricate the rotor or the bearing of the rotor. In order to achieve a high electromagnetic degree of efficiency, the outer casing wall of the rotor, i.e. of the rotor magnet, is moved as close as possible in terms of design to the stator winding. This results in only a very small gap being present between the rotor or rotor magnet and the inner wall of the wet area, through which relatively little liquid flows particularly during rotation of the rotor. In this respect a wet area zone which faces away from the liquid inlet can only be flushed through with difficulty via this gap. In particular, in such a rear, i.e. wet area zone facing away from the pump wheel, air and/or steam bubbles undesirably accumulate. Due to the rotation of the rotor, air and/or steam bubbles tend to accumulate in the near-axle centre of the wet area close to the motor shaft and not in an outer periphery close to the gap. At least one flow duct arranged in the magnet carrier can be used to circulate the liquid particularly well and air and/or steam bubbles can be discharged in particular so that there is no risk of the bearing of the rotor running dry, which would reduce the service life and the degree of efficiency of the pump. By discharging air and/or steam bubbles, the drive motor and thus also the pump also run more quietly.

The pump can have a pump wheel which can be driven by the electric drive motor and the motor shaft of the electric drive motor can also have a knurling to which the pump wheel is fastened. This ensures that the pump wheel is fastened particularly reliably on the motor shaft, which can increase the service life of the pump.

The following features can be used individually or in combination with one another in different embodiments. In general, the drive motor can be a brushless direct current wet running meter pump drive motor. The rotor magnet can generally be a permanent magnet ring which is fastened on the holder.

In general terms the direct current pump drive motor can generally be embodied as a wet running meter through which liquid passes and the permanent magnet rotor can be in direct contact here with the liquid. In all embodiments the magnet carrier can either be embodied in one piece or from a laminated core of several metal sheets stacked one on top of the other and connected to one another.

The invention also relates to a domestic appliance, in particular a dishwasher, a washing machine or a dryer, which has an inventive electric drive motor and/or an inventive pump, as described.

Different concrete exemplary embodiments of inventive electric drive motors are explained in more detail in the description which follows with reference to the appended figures. Concrete features of these exemplary embodiments can, independently of the concrete association in which they are mentioned, if necessary also considered individually or in combination, represent general features of the invention, in which:

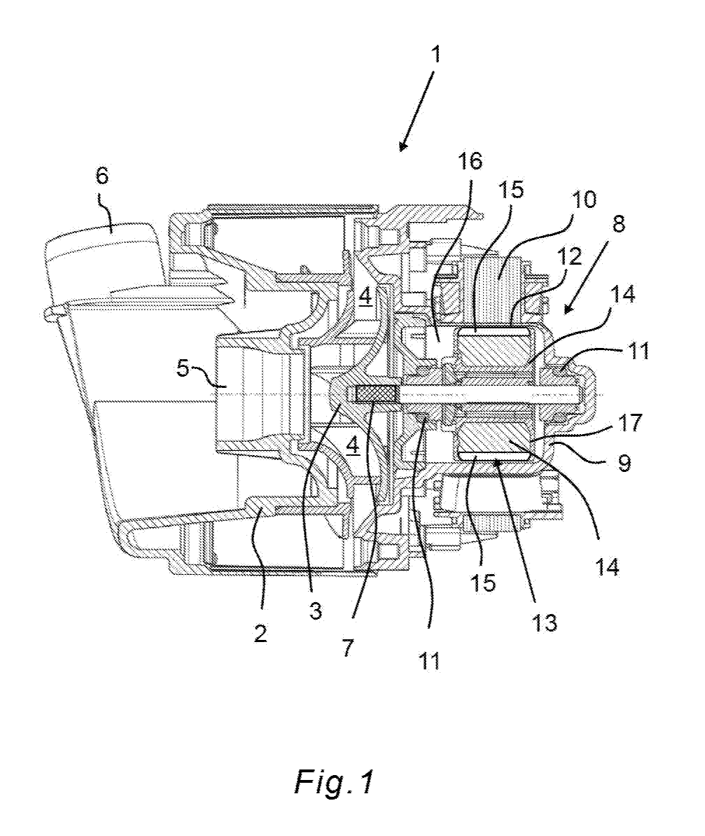

FIG. 1 shows a cross-sectional view of an exemplary pump of a domestic appliance with an inventive electric drive motor in the form of a wet running meter pump drive motor,

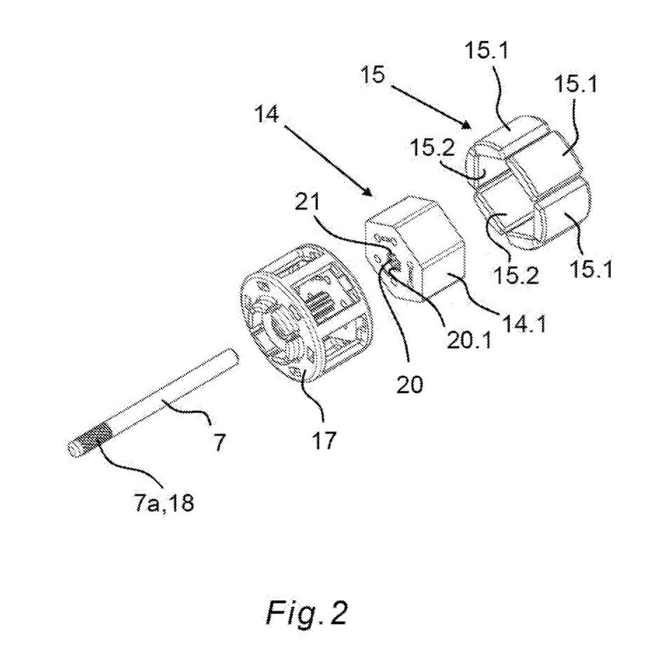

FIG. 2 shows a perspective exploded view of a first embodiment of a permanent magnet inner rotor of the inventive electric drive motor;

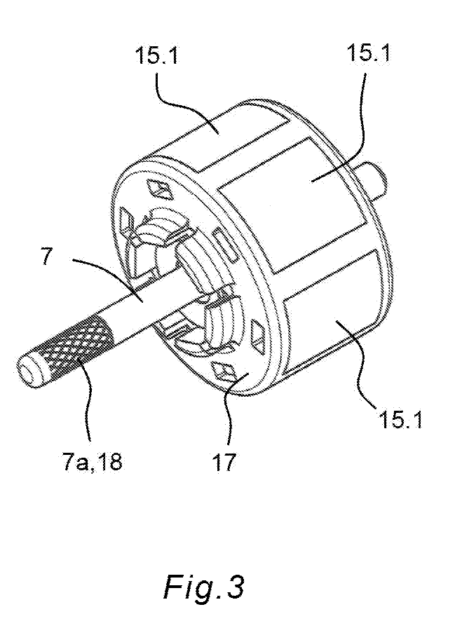

FIG. 3 shows a perspective view of the permanent magnet inner rotor according to FIG. 2 in an assembled state;

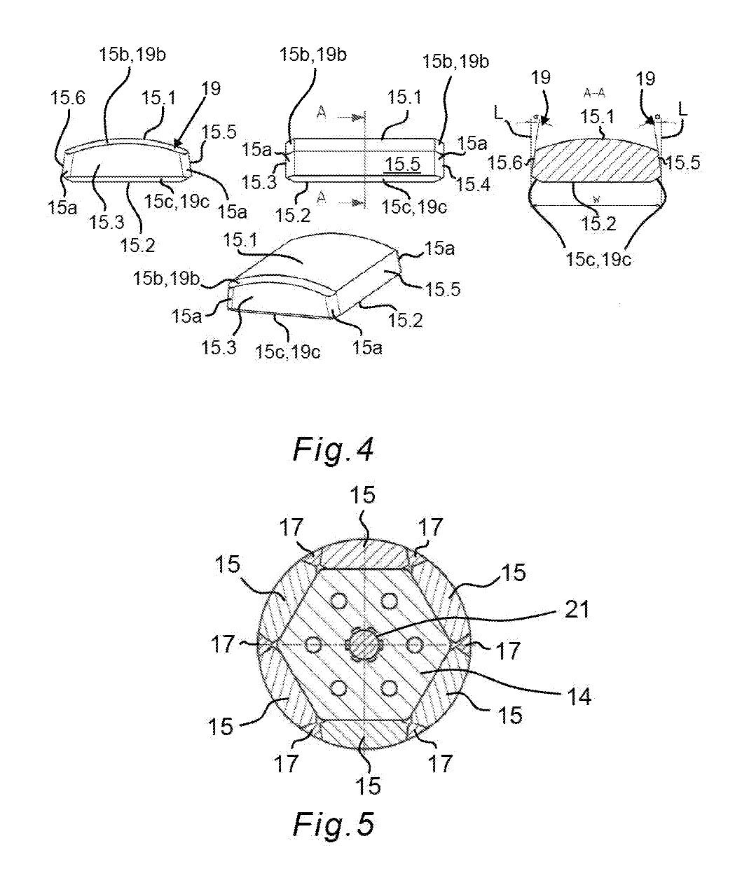

FIG. 4 shows an individual permanent magnet of the electric drive motor according to the first embodiment according to FIG. 2 and FIG. 3 in a front view, a side view, a cross-sectional view and in a perspective representation;

FIG. 5 shows a cross-sectional view of the assembled permanent magnet inner rotor of the first embodiment according to FIG. 3;

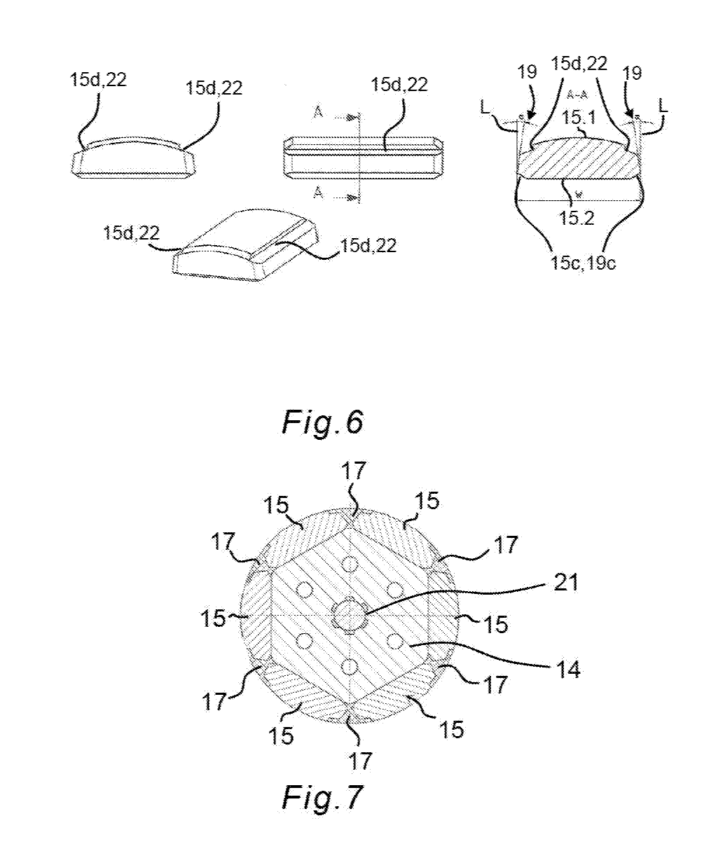

FIG. 6 shows an individual permanent magnet of the electric drive motor according to a second embodiment in a front view, a side view, a cross-sectional view and in a perspective representation;

FIG. 7 shows a cross-sectional view of the assembled permanent magnet inner rotor of the second embodiment according to FIG. 6, and

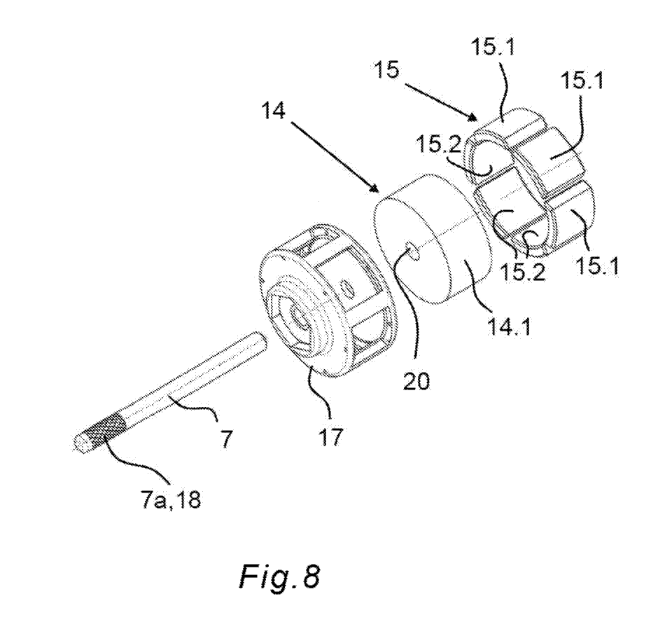

FIG. 8 shows a perspective exploded representation of a third embodiment of a permanent magnet inner rotor of the inventive electric drive motor.

A pump 1 of a domestic appliance shown by way of example in FIG. 1 has a pump housing 2, in which a pump wheel 3 is rotatably arranged. The pump wheel 3 has a number of blades 4, which are embodied and arranged to axially take in liquid via an inlet opening 5 and to radially discharge the same via an outlet opening 6. In the present exemplary embodiment, the pump 1 then forms a centrifugal pump in the design of a radial pump. The pump wheel 3 sits on a motor shaft 7 of a brushless direct current wet running meter pump drive motor 8 in a torsion-resistant manner.

The direct current wet running meter pump drive motor 8 is arranged in a motor housing 9. The motor housing 9, in the case of the present exemplary embodiment, is directly connected to the pump housing 2. If necessary the motor housing 9 can form an assembly together with the pump housing 2, or even be embodied in one piece. The direct current wet running meter pump drive motor 8 has an electrically actuatable stator winding 10 and a rotor 13 which can be driven in the field of the stator winding 10 and is rotatably mounted by means of the motor shaft 7 in the field between two opposing bearings 11.

The direct current wet running meter pump drive motor 8 of the exemplary embodiment shown is embodied as a wet running meter motor through which liquid passes, in which the rotor 13 is mounted in a wet area 16 within a motor housing 9, which is flooded by liquid from the pump housing 2. The stator winding 10 is arranged here in a dry environment outside of the motor housing 9.

In the exemplary embodiment shown, the rotor 13 has substantially the motor shaft 7, a magnet carrier 14 fastened to the motor shaft 7 in a torsion-resistant manner and permanent magnets 15 fixed on the magnet carrier 14 by means of a plastic cage 17 produced by means of injection molding.

This permanent magnet inner rotor is shown in more detail in an exploded representation in FIG. 2.

The motor shaft 7 has a front shaft end 7a, on which the pump wheel 3 is to be fastened. On this front shaft end 7a, the motor shaft 7 has a knurling 18 on its outer casing wall, said knurling being embodied to fix the pump wheel 3 to the motor shaft 7 in a torsion-resistant manner.

The permanent magnets 15 of the rotor 13 are in direct contact with the liquid (FIG. 1) with their outer surfaces 15.1 in the wet area 16 in the region of an annular gap 12 between the rotor 13 and the stator winding 10. The permanent magnets 15 are produced from a ferromagnetic material.

The rotor 13 mounted in a rotationally drivable manner in the wet area 16 of the pump 1 has a number of permanent magnets 15 arranged in an evenly distributed manner across a periphery, the outer surfaces 15.1 of which are in contact with a liquid of the wet area 16 which is disposed in the annular gap 12 of the electric drive motor 8.

In order to fasten the number of permanent magnets 15 on the magnet carrier 14, said permanent magnets 15 being arranged in a distributed manner on at least one lateral area 14.1 of the magnet carrier 14, the permanent magnets 15 are held in a form-fit manner in the manner of a frame on the magnet carrier 14 on the edge side by means of a plastic cage 17 produced by means of injection molding the magnet carrier 14.

To ensure that the plastic cage 17 produced by injection molding the magnet carrier 14 can hold the permanent magnets 15 in a form-fit manner on the magnet carrier 14, each permanent magnet 15 has at least one bevel 19 running around the outer surface 15.1, said bevel being filled by the plastic cage 17, as a result of which the respective permanent magnet 15 is enclosed in a form-fit manner by the plastic cage 17.

In the first embodiment according to FIG. 2 to FIG. 5, the magnet carrier 14 has a polygonal, in particular hexagonal cross-section. The magnet carrier 14 can be embodied to be solid, or structured in a manner known per se to the person skilled in the art from a stack of a number of polygonal, in particular hexagonal punched sheets.

The magnet carrier 14 has a hub 20, in which the motor shaft 7 is received. For a secure fastening of the motor shaft 7 in the magnet carrier 14, protruding ribs 21 are provided on an inner casing wall 20.1 of the hub 20, said ribs extending in particular in the axial direction.

A separate permanent magnet 15 sits in each case on each individual, in particular rectangular lateral area 14.1 of the cross-sectionally polygonal, in particular hexagonal magnet carrier 14. Each permanent magnet 15 has a planar base area 15.2 pointing in the direction of the magnet carrier 14 and touching the lateral area 14.1 of the magnet carrier 14 face to face.

As shown in particular in the representations in FIG. 4, each permanent magnet 15 has a front end wall 15.3, a rear end wall 15.4, a leading side wall 15.5 in the direction of rotation of the rotor 13 and a trailing side wall 15.6. The inventive at least one bevel 19 is formed in that the front end wall 15.3, the rear end wall 15.4, the leading side wall 15.5 and the trailing side wall 15.6 are each tapered inwards from a position L at right angles to a base area 15.2 of the permanent magnet 15 pointing in the direction of the magnet carrier 14 about an angle a such as is shown in particular in the cross-sectional representation in FIG. 4. In accordance with the invention the angle a can lie in a value range of 1 to 20 degrees and has, particularly in the exemplary embodiments shown, a value of approx. 8 degrees.

The four side edges 15a of the permanent magnet 15, which directly connect the front end wall 15.3, the rear end wall 15.4, the leading side wall 15.5 and the trailing side wall 15.6 in each case, are embodied rounded in order to form a single bevel 19 which runs around the outer surface 15.1 of the permanent magnet 15.

Both in the first embodiment according to FIG. 2 to FIG. 5 and also in the second embodiment according to FIG. 6 and FIG. 7, at least one surface edge 15b directly connecting the front end wall 15.3, the rear end wall 15.4, the leading side wall 15.5 and/or the trailing side wall 15.6 to the outer surface 15.1 in each case, in particular the surface edge 15b directly connecting the front end wall 15.3 and the rear end wall 15.4 to the outer surface 15.1 in each case is provided with an additional bevel 19b.

In the first embodiment according to FIG. 2 to FIG. 5, the base edges 15c, which in each case directly connect the front end wall 15.3, the rear end wall 15.4, the leading side wall 15.5 or the trailing side wall 15.6 to the base area 15.2 of the permanent magnet 15 pointing

in the direction of the magnet carrier 14, each indicate a further bevel 19c.

The cross-sectional representation according to FIG. 5 shows how the injection-molded plastic material of the plastic cage 17 encompasses the bevels 19 and 19c of the permanent magnets 15 in a form-fit manner in accordance with the first embodiment, in order to hold the permanent magnets 15 on the magnet carrier 14.

In the second embodiment according to FIG. 6 and FIG. 7, the permanent magnets 15 are firstly embodied in terms of design similarly to the first embodiment according to FIG. 2 to FIG. 5. Furthermore, the permanent magnets 15 of the second embodiment also have stepped surface edges 15d.

Therefore at least one surface edge 15d directly connecting the front end wall 15.3, the rear end wall 15.4, the leading side wall 15.5 and/or the trailing side wall 15.6 to the outer surface 15.1 in each case, in particular exclusively only the surface edges 15d directly connecting the leading side wall 15.5 and the trailing side wall 15.6 to the outer surface 15.1 in each case are embodied stepped.

The stepped surface edge 15d is formed by a recess 22, which has a width in the axial cross-section of the permanent magnet which amounts to between 10% and 15%, in particular 12% or 13% of the overall width of the permanent magnet. In the axial cross-section of the permanent magnet, the stepped surface edge formed by a recess has a minimal height of at least 0.5 millimeters, in particular at least 0.6 millimeters.

In the second embodiment as well, the at least one base edge 15c directly connecting the front end wall 15.3, the rear end wall 15.4, the leading side wall 15.5 and/or the trailing side 15.6 to the base area 15.2 of the permanent magnet 15 pointing in the direction of the magnet carrier 14 in each case is provided with the further bevel 19c.

The cross-sectional representation according to FIG. 7 shows how the injection-molded plastic material of the plastic cage 17 encompasses the bevels 19 and 19c and the stepped recesses 22 of the permanent magnets 15 in a form-fit manner according to the second embodiment, in order to hold the permanent magnets 15 on the magnet carrier 14.

In the third embodiment according to FIG. 8, each permanent magnet 15 has a cross-sectionally circular arc-shaped base area 15.2 pointing in the direction of the magnet carrier 14, and the magnet carrier 14 has a circular cross-section.

### LIST OF REFERENCE CHARACTERS

1 Pump
2 Pump housing
3 Pump wheel
4 Blades
5 Inlet opening
6 Outlet opening
7 Motor shaft
7a Front shaft end
8 Drive motor
9 Motor housing
10 Stator winding
11 Bearing
12 Annular gap
13 Rotor
14 Magnet carrier
14.1 Lateral area
15 Permanent magnets
15.1 Outer surface
15.2 Base area
15.3 Front end face
15.4 Rear end face
15.5 Leading side wall
15.6 Trailing side wall
15a Side edges
15b, d Surface edge
15c Base edges
16 Wet area
17 Plastic cage
18 Knurling
19 Bevel
19b Additional bevel
19c Further bevel
20 Hub
20.1 Inner lateral wall
21 Ribs
22 Recess

1-15. (canceled)

16. An electric drive motor for a pump, comprising:
an electrically actuatable stator winding; and
a rotor mounted for rotation in a field of the stator winding in the presence of an annular gap, said rotor including a motor shaft, a magnet carrier disposed on the motor shaft, and at least one permanent magnet arranged on the magnet carrier, said magnet carrier being made from a ferromagnetic chrome steel.

17. The electric drive motor of claim 16, wherein the chrome steel is a ferritic or martensitic chrome steel with a chrome proportion of at least 10.5%.

18. The electric drive motor of claim 16, wherein the chrome steel is a nickel-free chrome steel.

19. The electric drive motor of claim 16, wherein the chrome steel has a chrome proportion of 16% to 18%.

20. The electric drive motor of claim 16, wherein the chrome steel has a chrome proportion of approx. 17%.

21. The electric drive motor of claim 16, wherein the chrome steel is of a material number 1.4016 according to EN 10027-2 (X6Cr17, AISI 430).

22. The electric drive motor of claim 16, wherein the magnet carrier includes a laminated core of several metal sheets stacked on top of one another and connected to one another.

23. The electric drive motor of claim 16, wherein the motor shaft is made from a chrome steel.

24. The electric drive motor of claim 23, wherein the chrome steel for the motor shaft is a curable chrome steel.

25. The electric drive motor of claim 23, wherein the chrome steel for the motor shaft is austenitic or martensitic chrome steel.

26. The electric drive motor of claim 23, wherein the chrome steel for the motor shaft has a chrome proportion of 15% to 17% and a nickel proportion of 3% to 5%.

27. The electric drive motor of claim 26, wherein the chrome proportion is approx. 16% and the nickel proportion is approx. 4%.

28. The electric drive motor of claim 23, wherein the chrome steel for the motor shaft, is of a material number 1.4542 according to EN 10027-2 (X5CrNiCuNb16-4, AISI 630).

29. The electric drive motor of claim 16, wherein the rotor has a number of permanent magnets arranged in a distributed manner about the magnet carrier, said magnet carrier having a polygonal cross-section, each of the permanent magnets having a planar base area pointing in a direction of the magnet carrier.

30. The electric drive motor of claim 29, wherein the magnet carrier has a hexagonal cross section.

31. The electric drive motor of claim 16, wherein the rotor has a number of permanent magnets arranged in a distributed manner about the magnet carrier, said magnet carrier having a circular cross-section, each of the permanent magnets having a base area which points in a direction of the magnet carrier and has a circular arc-shaped cross-section.

32. The electric drive motor of claim 29, further comprising a plastic cage produced by injection molding around the magnet carrier to thereby fasten the permanent magnets on the magnet carrier.

33. The electric drive motor of claim 16, wherein the magnet carrier has a hub for receiving the motor shaft, said hub having an inner casing wall provided with projecting ribs.

34. The electric drive motor of claim 33, wherein the ribs extend in an axial direction.

35. A pump, comprising an electric drive motor which includes an electrically actuatable stator winding, and a rotor mounted for rotation in a wet area of the pump, said rotor comprising a motor shaft, a magnet carrier disposed on the motor shaft and made from a ferromagnetic chrome steel, and at least one permanent magnet arranged on the magnet carrier and having an outer surface in contact with a liquid of the wet area which is disposed in an annular gap of the electric drive motor between the stator winding and the rotor.

36. The pump of claim 35, further comprising a pump wheel configured for propulsion by the electric drive motor, said motor shaft of the electric drive motor having a knurling, to which the pump wheel is fastened.

37. The pump of claim 35, wherein the stator winding of the electric drive motor is arranged in a dry environment outside the wet area.

38. A domestic appliance, comprising:
an electric drive motor comprising an electrically actuatable stator winding, and a rotor mounted for rotation in a field of the stator winding in the presence of an annular gap, said rotor including a motor shaft, a magnet carrier disposed on the motor shaft and made from a ferromagnetic chrome steel, and at least one permanent magnet arranged on the magnet carrier; and/or
a pump comprising an electric drive motor which includes a rotor mounted for rotation in a wet area of the pump, said rotor comprising a motor shaft, a magnet carrier disposed on the motor shaft and made from a ferromagnetic chrome steel, and at least one permanent magnet arranged on the magnet carrier and having an outer surface in contact with a liquid of the wet area which is disposed in an annular gap of the electric drive motor between a stator winding and the rotor.

39. The domestic appliance of claim 37, constructed in the form of a dishwasher, washing machine, vacuum cleaner, or dryer.
